(19) United States
(12) Patent Application Publication
(10) Pub. No.: US 2021/0311987 A1
(43) Pub. Date: Oct. 7, 2021

(54) DIGITAL ASSISTANT WORD CHOICE

(71) Applicant: MOTOROLA SOLUTIONS, INC., Chicago, IL (US)

(72) Inventors: HAIM KAHLON, SHOAM (IL); DAFNA LANGERMAN, GIVATAYIM (IL); JACOB SHEM TOV, JERUSALEM (IL)

(21) Appl. No.: 16/841,747

(22) Filed: Apr. 7, 2020

(51) Int. Cl. G06F 16/61; G10L 15/08; G10L 25/84; G06F 16/635

(52) U.S. Cl. CPC G06F 16/61; G10L 15/08; G10L 2015/088; G06F 16/635; G10L 25/84

(57) ABSTRACT

A database of repeated words/phrases will be built along with the user context experienced when the word was repeated (or asked to be repeated). A virtual partner will determine a user's context, and then avoid words that were repeated for users in similar contexts. Substitute words may be provided for those often-repeated words/phrases.

### BACKGROUND OF THE INVENTION

Tablets, laptops, phones (e.g., cellular or satellite), mobile (vehicular) or portable (personal) two-way radios, and other communication devices are now in common use by users, such as first responders (including firemen, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such communication devices further comprise, or provide access to, electronic digital assistants (or sometimes referenced as “virtual partners”) that may provide the user thereof with valuable information in an automated (e.g., without further user input) or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as Siri provided by Apple, Inc.® and Google Now provided by Google, Inc.®, are software applications running on underlying electronic hardware that are capable of understanding natural language, and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, warning users of nearby dangers such as traffic accidents or environmental hazards, answering queries, and providing many other types of information in a reactive or proactive manner.

In mission critical situations, obtaining essential information as fast as possible from a virtual partner is crucial. In many environments or situations, a user may not understand the virtual partner, and ask the virtual partner to repeat itself. This back and forth may take several iterations which consume critical time to get the required information. It would be beneficial to reduce such exchanges.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates an operational environment for the present invention.

FIG. 2 depicts an example communication system that incorporates a personal-area network and a digital assistant.

FIG. 3 is a more-detailed view of a personal-area network of FIG. 2.

FIG. 4 illustrates a digital assistant.

FIG. 5 is a flow chart showing operation of the device of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a database of often-repeated words/phrases will be built along with the user context experienced when the word was asked to be repeated. A virtual partner will determine a user's context, and then avoid words/phrases that were repeated for users in similar contexts by substituting other words/phrases in the avoided-words/phrases place.

As an example of the above, consider the following example: A virtual partner wishes to warn an officer that a suspect is carrying a weapon and has a violent background. The officer is experiencing a very noisy background. It is known (from accessing the database) that the phrases “carrying a weapon” and “violent background” are frequent phrases that need repeating in noisy conditions. Because of this, the virtual partner will warn the officer without using the frequently-repeated words/phrases (i.e., frequently repeated for the current context). For example, the virtual partner may simply state that the suspect is armed and dangerous.

As is evident, the virtual partner will have access to a database of learned, often-repeated words/phrases and the particular context a user experienced when the words/phrases were asked to be repeated. The database may also comprise substitute words/phrases for the often-repeated words/phrases. The virtual partner will track a user's context (e.g. ambient noise level, current task, user's movements (e.g., if running, . . . , etc.). When a user's context matches a particular context (e.g., when the user is in a noisy environment), the database will be accessed to determine those words/phrases that should be avoided by substituting those words/phrases with easier-understood words/phrases for that context. The virtual partner will then substitute the words/phrases with the easier-understood words/phrases for the user's current context.

The database will be created by determining when a user asks a virtual partner or a human to repeat themselves. For example, words/phrases like “what”, “again”, “repeat”, “please repeat”, “10-9”, . . . , etc. will trigger the system to determine a user's context and log/store the repeated words/phrases in the database along with the current context. Easier-understood words/phrases may be determined by slightly modifying the “repeated” phrase to determine if the user again askes for the phrase to be repeated. The easier-understood words/phrases are then added to the database as substitute words/phrases for a particular context. As is evident, a human's voice asking for a virtual partner (or human) to repeat themselves, along with the current context of the human that asked for the word/phrase to be repeated, is utilized to create the database of easier-understood words/phrases for a particular context.

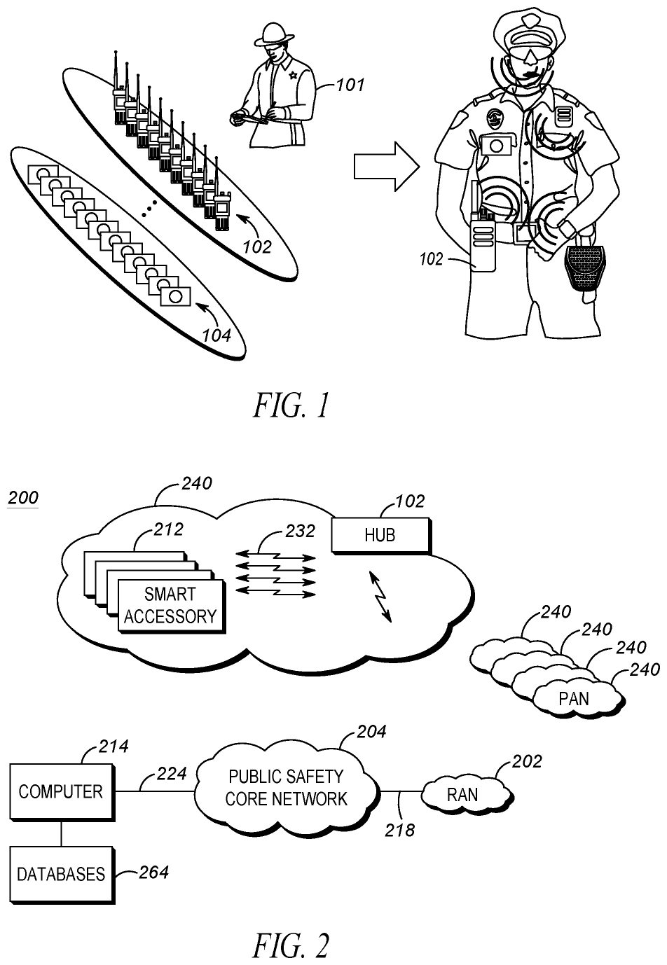

Turning now to the drawings, wherein like numerals designate like components, FIG. 1 illustrates an operational environment for the present invention. As shown, a public safety officer 101 will be equipped with devices 102, 104 that determine various physical and environmental conditions surrounding the public-safety officer (i.e., the officer's context). The officer's context is generally reported back to a dispatch operator so an appropriate action may be taken. For example, future police officers may have a sensor (not shown in FIG. 1) that determines when a gun is drawn. Upon detecting that an officer has drawn their gun, a notification may be sent back to the dispatch operator so that, for example, other officers in the area may be notified of the situation. As mentioned above, the officer's context (as determined by the devices, e.g., devices 102 and 104) is used to create the database of often repeated words/phrases for the particular context.

It is envisioned that the public-safety officer will have an array of shelved devices available to the officer at the beginning of a shift. The officer will select the devices off the shelf, and form a personal area network (PAN) with the devices that will accompany the officer on his shift. For example, the officer may pull a gun-draw sensor, a body-worn camera, a wireless microphone, a smart watch, a police radio, smart handcuffs, a man-down sensor, . . . , etc. All devices pulled by the officer will be configured to form a PAN by associating (pairing) with each other and communicating wirelessly among the devices. One or several devices may be configured with a digital assistant (virtual partner).

A method called bonding is typically used for recognizing specific devices and thus enabling control over which devices are allowed to connect to each other when forming the PAN. Once bonded, devices then can establish a connection without user intervention. A bond is created through a process called “pairing”. The pairing process is typically triggered by a specific request by the user to create a bond from a user via a user interface on the device.

As shown in FIG. 1, public-safety officer 101 has an array of devices to use during the officer's shift. For example, the officer may pull one radio 102 and one camera 104 for use during their shift. Other devices not shown in FIG. 1 may be pulled as well. As shown in FIG. 1, officer 101 will preferably wear the devices during a shift by attaching the devices to clothing. These devices will form a PAN throughout the officer's shift.

FIG. 2 depicts an example communication system 200 that incorporates PANs created as described above. System 200 includes one or more radio access networks (RANs) 202, a public-safety core network 204, hub (PAN master device) 102, local devices (slave devices that serve as smart accessories/sensors) 212, computer 214, and communication links 218, 224, and 232. In a preferred embodiment of the present invention, hub 102 and devices 212 form PAN 240, with communication links 232 between devices 212 and hub 102 taking place utilizing a short-range communication system protocol such as a Bluetooth™ communication system protocol. Each officer will have an associated PAN 240. Thus, FIG. 2 illustrates multiple PANs 240 associated with multiple officers.

RAN 202 includes typical RAN elements such as base stations, base station controllers (BSCs), routers, switches, and the like, arranged, connected, and programmed to provide wireless service to user equipment (e.g., hub 102, and the like) in a manner known to those of skill in the relevant art. RAN 202 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, RAN 202 may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, RAN 202 may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

Public-safety core network 204 may include one or more packet-switched networks and/or one or more circuit-switched networks, and in general provides one or more public-safety agencies with any necessary computing and communication needs, transmitting any necessary public-safety-related data and communications.

Hub 102 serves as a PAN master device, and may be any suitable computing and communication devices configured to engage in wireless communication with the RAN 202 over the air interface as is known to those in the relevant art. Moreover, one or more hub 102 are further configured to engage in wired and/or wireless communication with one or more local device 212 via the communication link 232. Hub 102 will be configured to determine when to forward information via RANs 202 based on a combination of device 212 inputs. In one embodiment, all information received from sensors 212 will be forwarded to computer 214 via RAN 202. In another embodiment, hub 102 will filter the information sent, and only send high-priority information back to computer 214.

It should also be noted that any one or more of the communication links 218, 224, could include one or more wireless-communication links and/or one or more wired-communication links.

Devices 212 and hub 102 may comprise any device capable of forming a PAN. For example, devices 212 may comprise a gun-draw sensor, a body temperature sensor, an accelerometer, a heart-rate sensor, a breathing-rate sensor, a camera, a GPS receiver capable of determining a location of the user device, smart handcuffs, a clock, calendar, environmental sensors (e.g. a thermometer capable of determining an ambient temperature, humidity, presence of dispersed chemicals, radiation detector, etc.), an accelerometer, a biometric sensor (e.g., wristband), a barometer, speech recognition circuitry, a gunshot detector, . . . , etc. Some examples follow:

A sensor-enabled holster 212 may be provided that maintains and/or provides state information regarding a weapon or other item normally disposed within the user's sensor-enabled holster 212. The sensor-enabled holster 212 may detect a change in state (presence to absence) and/or an action (removal) relative to the weapon normally disposed within the sensor-enabled holster 212. The detected change in state and/or action may be reported to the portable radio 102 via its short-range transceiver. In some embodiments, the sensor-enabled holster may also detect whether the first responder's hand is resting on the weapon even if it has not yet been removed from the holster and provide such information to portable radio 102. Other possibilities exist as well.

A biometric sensor 212 (e.g., a biometric wristband) may be provided for tracking an activity of the user or a health status of the user 101, and may include one or more movement sensors (such as an accelerometer, magnetometer, and/or gyroscope) that may periodically or intermittently provide to the portable radio 102 indications of orientation, direction, steps, acceleration, and/or speed, and indications of health such as one or more of a captured heart rate, a captured breathing rate, and a captured body temperature of the user 101, perhaps accompanying other information.

An accelerometer 212 may be provided to measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

A heart rate sensor 212 may be provided and use electrical contacts with the skin to monitor an electrocardiography (EKG) signal of its wearer, or may use infrared light and imaging device to optically detect a pulse rate of its wearer, among other possibilities.

A breathing rate sensor 212 may be provided to monitor breathing rate. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperature sensor 212 may be provided, and includes an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities.

Computer 214 comprises, or is part of a computer-aided-dispatch center, manned by an operator providing necessary dispatch operations. For example, computer 214 typically comprises a graphical user interface that provides the dispatch operator necessary information about public-safety officers. As discussed above, much of this information originates from devices 212 providing information to hub 102, which forwards the information to RAN 202 and ultimately to computer 214. Computer 214 comprises a virtual partner (e.g., a microprocessor serving as a virtual partner) that is configured to receive sensor data from sensors 212 and keep track of a user's context. For example, for each user of the system, computer 214 may track the user's current sensor data to determine a context for the user. Any voice transmissions may be analyzed as well. This information may be used to compile a database of often-repeated words/phrases for a particular context. The information is preferably stored in database 264.

With the above in mind, computer 214 is also configured with a natural language processing (NLP) engine configured to determine the intent and/or content of the any over-the-air voice transmissions received by users. The NLP engine may also analyze oral queries and/or statements received by any user and provide responses to the oral queries and/or take other actions in response to the oral statements.

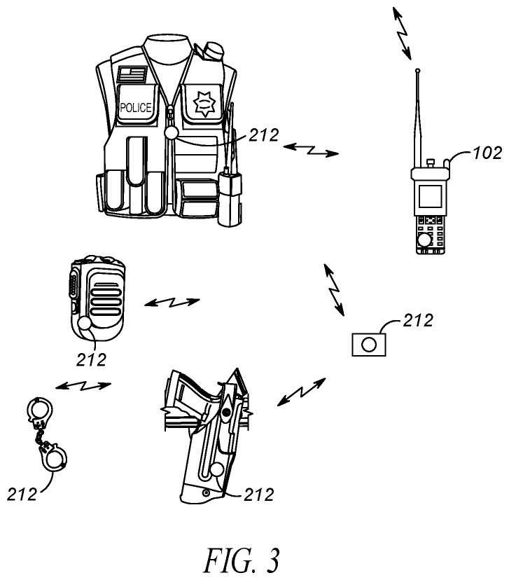

FIG. 3 depicts another view of a personal-area network 240 of FIG. 2. Personal-area network comprises a very local-area network that has a range of, for example 10 feet. As shown in FIG. 3, various devices 212 are that attach to clothing utilized by a public-safety officer. In this particular example, a bio-sensor is located within a police vest, a voice detector is located within a police microphone, smart handcuffs 212 are usually located within a handcuff pouch (not shown), a gun-draw sensor is located within a holster, and a camera 212 is provided.

Devices 212 and hub 102 form a PAN 240. PAN 240 preferably comprises a Bluetooth™ PAN. Devices 212 and hub 102 are considered Bluetooth™ devices in that they operate using a Bluetooth™, a short range wireless communications technology at the 2.4 GHz band, commercially available from the “Bluetooth™ special interest group”. Devices 212 and hub 102 are connected via Bluetooth™ technology in an ad hoc fashion forming a PAN. Hub 102 serves as a master device while devices 212 serve as slave devices.

Hub 102 provides information to the officer, and/or forwards local status messages describing each sensor state/trigger event over a wide-area network (e.g., RAN/Core Network) to computer 214. In alternate embodiments of the present invention, hub 102 may forward the local status alerts for each sensor to mobile and non-mobile peers (shift supervisor, peers in the field, etc), or to the public via social media. RAN core network preferably comprises a network that utilizes a public-safety over-the-air protocol.

As described above, digital-assistant functionality and database creation are provided by computer 214, however, in alternate embodiments of the present invention, this functionality may be provided by hub 102, or any other network device shown in FIG. 2. The functionality may also be distributed among several devices shown in FIG. 2. Regardless of where the digital-assistant functionality lies, the digital-assistant (e.g., logic circuitry and a NLP) will determine a user's context, determine often-repeated words/phrases for the context, determine substitute words/phrases for the context, and substitute the substitute words/phrases for often-repeated words/phrases when that context exists. The digital assistant will also create a dictionary of often-repeated words/phrases, along with the context. Possible substitute words/phrases may be included in the database.

As an example of the above, consider the following example: A police officer is currently in a foot chase with a suspect. An accelerometer 112 indicates to computer 214 that the officer is running. During the foot chase, the officer requests some information from a virtual partner. For example, the officer may ask the virtual partner if any crimes have been reported in the area during the past 24 hours. The virtual partner may determine that a homicide investigation is being conducted for a 25-year-old male found three blocks away. However, upon accessing database 264, it is determined that the term “homicide investigation” is often repeated for users in a similar context as the current officer. The database suggests substitute words/phrases “death inquiry” for “homicide investigation” for those officers running. The virtual partner will respond with “a death inquiry is being conducted for a 25-year-old male found three blocks away”.

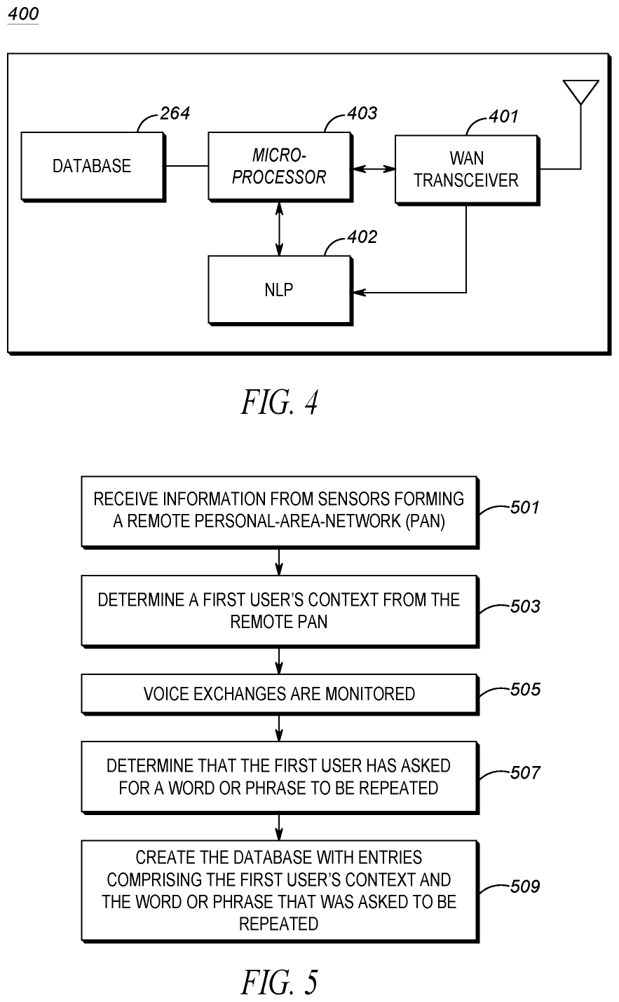

With the above in mind, FIG. 4 sets forth a schematic diagram that illustrates a device 400 for providing substitute words/phrases as described above. In an embodiment, the device is embodied within computer 214, however in alternate embodiments the device may be embodied within the public-safety core network 204, or more computing devices in a cloud compute cluster (not shown), hub 102, or some other communication device not illustrated in FIG. 2, and/or may be a distributed communication device across two or more entities.

FIG. 4 shows those components (not all necessary) for device 400 to provide virtual-partner functionality using substitute words/phrases as described above as well as database creation as described above. For example, for ease of illustration a graphical user interface that provides the dispatch operator necessary information about public-safety officers is not shown since that component is not necessary for understanding the following discussion. As shown, device 400 may include a wide-area-network (WAN) transceiver 401 (e.g., a transceiver that utilizes a public-safety communication-system protocol), Natural Language Processor (NLP) 402, logic circuitry 403 (which may serve as a digital assistant). In other implementations, device 400 may include more, fewer, or different components. Regardless, all components are connected via common data busses as known in the art.

WAN transceiver 401 may comprise well known long-range transceivers that utilize any number of network system protocols. (As one of ordinary skill in the art will recognize, a transceiver comprises both a transmitter and a receiver for transmitting and receiving data). For example, WAN transceiver 401 may be configured to utilize a next-generation cellular communications protocol operated by a cellular service provider, or any public-safety protocol such as an APCO 25 network or the FirstNet broadband network. WAN transceiver 401 receives communications from officers, as well as sensor data from those officers. It should be noted that WAN transceiver 401 is shown as part of device 400, however, WAN transceiver 401 may be located in RAN 202 (e.g., a base station of RAN 202), with a direct link to device 400.

NLP 402 may be a well known circuitry to analyze, understand, and derive meaning from human language in a smart and useful way. By utilizing NLP, automatic summarization, translation, named entity recognition, relationship extraction, sentiment analysis, speech recognition, and topic segmentation can take place and thus determine that a user asked to repeat words/phrases by using words like “what”, “again”, “10-9”, “please repeat”, . . . etc. The repeated word/phrases can also be detected and identified and used as substitute words/phrases when the user does not ask for the words/phrases to be repeated.

Logic circuitry 403 comprises a digital signal processor (DSP), general purpose microprocessor, a programmable logic device, or application specific integrated circuit (ASIC) and is configured to compile a database of often-repeated words/phrases for a particular user context, along with substitute words/phrases for the particular user context. Logic circuitry 403 along with NLP 402 is also configured to serve as a digital assistant/virtual partner in order to provide the substitute words/phrases as described above. For example, logic circuitry may provide the user thereof with valuable information in an automated (e.g., without further user input) or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

Database 264 is provided. Database 264 comprises standard memory (such as RAM, ROM, . . . , etc) and serves to store a context and often-repeated words/phrases for that context, along with substitute words/phrases for the often-repeated words/phrases. This is illustrated in Table 1.

TABLE 1
Context, often-repeated words/phrases, and substitute
words/phrases for the often-repeated words/phrases.

| Context | Often-Repeated Word | Substitute Word |
|---|---|---|
| User Running | Homicide | Murder |
| Noisy Environment | Automobile | Vehicle |
| . . . | . . . | . . . |
| Car Chase | License Plate | Tag |

With the above in mind, FIG. 4 provides for an apparatus comprising a Wide-Area-Network (WAN) transceiver configured to receive information from sensors forming a remote personal-area-network (PAN) and logic circuitry configured to determine a first user's context from the remote PAN, monitor voice exchanges between the first user and other people or digital assistants, determine that the first user has asked for a word or phrase to be repeated, and create a database with entries comprising the first user's context and the word or phrase that was asked to be repeated.

As discussed, the logic circuitry is also configured to determine a substitute word or phrase for the word or phrase to be repeated and create the database with an entry comprising the substitute word or phrases.

As discussed, the logic circuitry is also configured to determine that a second user is experiencing a similar context as that of the first user's context and access the database to create a digital-assistant communication to the second user that avoids the word or phrase to be repeated.

In one embodiment of the present invention the context and the similar context comprises an amount of background noise. When this is the case, the apparatus of FIG. 4 comprises a Wide-Area-Network (WAN) transceiver configured to receive an amount of background noise from a microphone, and logic circuitry configured to determine a first user's background noise from the microphone, monitor voice exchanges between the first user and other people or digital assistants, determine that the first user has asked for a word or phrase to be repeated, create a database with entries comprising an amount of first user's background noise and the word or phrase that was asked to be repeated, determine a substitute word or phrases for the word or phrase to be repeated, create the database with an entry comprising the substitute word or phrases, determine that a second user is experiencing a similar amount of background noise as that of the first user's background noise, and access the database to create a digital-assistant communication to the second user that avoids the word or phrase to be repeated.

FIG. 5 is a flow chart showing operation of the device of FIG. 4. More particularly, the logic flow of FIG. 5 shows those steps (not all necessary) for creating a database as shown in Table 1. The logic flow begins at step 501 where WAN transceiver 401 receives information from sensors forming a remote personal-area-network (PAN). In one embodiment of the present invention, at least one sensor comprises a remote microphone, and the information comprises an amount of background noise. The “information” received from the sensors is used to determine a “context” of the user. Additionally, the sensor is considered “remote” in that it is distant (e.g., a physical distance greater than a mile) to the WAN transceiver.

Continuing, at step 503, logic circuitry 403 determines a first user's context from the remote PAN. Voice exchanges are monitored by logic circuitry 403 using WAN transceiver 401 (step 505). These voice exchanges may comprise voice exchanges between the first user and digital assistants, or voice exchanges between the first user and other people.

At step 507, logic circuitry 403 determines that the first user has asked for a word or phrase to be repeated, and creates the database with entries comprising the first user's context and the word or phrase that was asked to be repeated (step 509).

It should be noted that logic circuitry 403 may keep track of the number of times a particular word or phrase was asked to be repeated, and then add the particular word or phrase to the database only if asked to be repeated a predetermined number of times by the user, or by multiple users.

As discussed above, logic circuitry 403 will use NLP 402 to determine a substitute word or phrases for the word or phrase to be repeated create the database with an entry comprising the substitute word or phrases. As discussed above, the database will preferably be created with substitute words or phrases only if they are not asked to be repeated. Thus, logic circuitry 403 will determine if the substitute word or phrase was asked to be repeated, and if not, then add the substitute word or phrase to the database.

When the above is done, logic circuitry 403 can then determine that a second user is experiencing a similar context as that of the first user's context and access the database to create a digital-assistant communication to the second user that avoids the word or phrase to be repeated.

As discussed the step of determining the user's context from the remote PAN may comprise determining a police officer's context from remote sensors worn by the police officer. The police officer's context may comprise an amount of background noise from a microphone used as a remote sensor.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for creating a database, the method comprising the steps of:
receiving information from sensors forming a remote personal-area-network (PAN);
determining a first user's context from the remote PAN;
monitoring voice exchanges between the first user and other people or digital assistants;
determining that the first user has asked for a word or phrase to be repeated; and
creating the database with entries comprising the first user's context and the word or phrase that was asked to be repeated.

2. The method of claim 1 further comprising the steps of:
determining a substitute word or phrases for the word or phrase to be repeated; and
creating the database with an entry comprising the substitute word or phrases.

3. The method of claim 2 further comprising the steps of:
determining that a second user is experiencing a similar context as that of the first user's context; and
accessing the database to create a digital-assistant communication to the second user that avoids the word or phrase to be repeated.

4. The method of claim 3 wherein the step of determining the first user's context from the remote PAN comprises determining a police officer's context from remote sensors worn by the police officer.

5. The method of claim 4 wherein the first user's context comprises an amount of background noise from a microphone used as a remote sensor.

6. An apparatus comprising:
a Wide-Area-Network (WAN) transceiver configured to receive information from sensors forming a remote personal-area-network (PAN);
logic circuitry configured to:
determine a first user's context from the remote PAN;
monitor voice exchanges between the first user and other people or digital assistants;
determine that the first user has asked for a word or phrase to be repeated; and
create a database with entries comprising the first user's context and the word or phrase that was asked to be repeated.

7. The apparatus of claim 6 wherein the logic circuitry is also configured to:
determine a substitute word or phrases for the word or phrase to be repeated; and
create the database with an entry comprising the substitute word or phrases.

8. The apparatus of claim 7 wherein the logic circuitry is also configured to:
determine that a second user is experiencing a similar context as that of the first user's context; and
access the database to create a digital-assistant communication to the second user that avoids the word or phrase to be repeated.

9. The apparatus of claim 8 wherein the first-user's context and the similar context comprises an amount of background noise.

10. An apparatus comprising:
a Wide-Area-Network (WAN) transceiver configured to receive an amount of background noise from a microphone;
logic circuitry configured to:
determine a first user's background noise from the microphone;
monitor voice exchanges between the first user and other people or digital assistants;
determine that the first user has asked for a word or phrase to be repeated;
create a database with entries comprising an amount of first user's background noise and the word or phrase that was asked to be repeated;
determine a substitute word or phrases for the word or phrase to be repeated;
create the database with an entry comprising the substitute word or phrases;
determine that a second user is experiencing a similar amount of background noise as that of the first user's background noise; and
access the database to create a digital-assistant communication to the second user that avoids the word or phrase to be repeated.
